(19) United States
(12) Patent Application Publication
(10) Pub. No.: US 2004/0072120 A1
(43) Pub. Date: Apr. 15, 2004

(54) Mass-customized wire forming system

(76) Inventor: Mark D. Lauren, Amherst, NY (US)

Correspondence Address: Martin G. Linihan, Hodgson Russ LLP, Suite 2000, One M&T Plaza, Buffalo, NY, 14203-2391, US

(21) Appl. No.: 10/460,332

(22) Filed: Jun. 12, 2003

Related U.S. Application Data
(60) Provisional application No. 60/387,959, filed on Jun. 12, 2002.

(51) Int. Cl. A61C 3/00

(52) U.S. Cl. 433/24; 433/20

(57) ABSTRACT

A mass-customization method is described for the computer-based design and production of complex 3-dimensional wireforms for fabricating orthodontic appliances. The method comprises of: 1) digitizing a patient's dentition into a computer, 2) designing 3-dimensional polylines on the dental models using a computer, 3) translating the mathematical representation of the wires into algorithms for commanding wire bending machines, and 4) using wire bending machines to produce near net-shape wires. In this way, wires for retainers, Herbst appliances, palatal expanders, and other orthodontic appliances are readily designed and produced. Near net-shaped wires are produced by having the bending algorithms consider wire diameter, springback of the metal, and the mechanics of the bending head.

### CROSS REFERENCE TO A RELATED APPLICATION

Applicant claims priority based on U.S. provisional patent application No. 60/387,959 filed Jun. 12, 2002 and entitled “Method For Automated Wire Designing And Bending” which is incorporated herein by reference.

### BACKGROUND OF THE INVENTION

The present invention relates to the computer-based design and manufacture of 3-dimensional custom wires used to fabricate orthodontic appliances, and more particularly, to the computer-based design of wires based upon a patient's existing dentition and not upon the movement of teeth into positions of less malocclusion.

For over 100 years, orthodontic appliances have been produced by manually bending wires. In general, these appliances consist of wires embedded in a plastic matrix. Such appliances include retainers, Herbst appliances, and appliances for treating sleep apnea. The process of producing wires for producing such appliances typically involves using a set of bending instruments and cutters to fashion a straight length of wire to fit a dental cast. Considerable skill is required while keeping time to a minimum. This invention provides mass-customization methods for computerizing and automating this process, which results in substantially reduced cost, increased speed and accuracy, and more consistent wire properties. Wire properties are improved by eliminating repeated bending, which can lead to strain hardening and weakening certain metals.

Orthodontic treatment classically involves moving teeth from an original state of malocclusion to a final state of desired occlusion. This is usually carried out using a series of arch wires that engage brackets that are cemented to the teeth. A wide array of brackets is available commercially. Standard brackets are produced using a variety of prescriptions (different slot sizes, angulations, and torque). Brackets are available in standard sizes as well as mini and low profile. Brackets are also available in a range of materials including stainless steel, ceramic, ceramic reinforced plastic, gold-reinforced ceramic, nickel-free materials, and plastics. Self-ligating brackets represent another subset. Some brackets also come precoated with adhesive. All commercially available brackets are designed to fit an average tooth anatomy.

A broad assortment of archwires is also available. Wires may be made with round or rectangular cross sections in a range of dimensions. Materials also vary, including: stainless steel, titanium molybdenum alloys, and nickel-titanium. In addition, a variety of archform sizes and geometries are available. It is also common for the Orthodontist to place specific bends in arch wires to effect specific tooth movements.

The practicing Orthodontist is faced with a large number of possible combinations of brackets and archwires. The breadth of the selection itself indicates that no one particular combination of bracket design and archwire-type is significantly superior. On a practical clinical level, generic sets of brackets and arch wires are made to work on all patients. This methodology is accepted orthodontic practice. In spite of the flood of bracket designs, advances in bracket design have not significantly affected the ease or efficiency of orthodontic treatment. Claims of shortened treatment times using the latest bracket design are common. Bracket and archwire selection remains a subjective issue for Orthodontists.

Advances in 3-dimensional solid modeling software and metal injection molding have also made the manufacturing of commercial orthodontic brackets technically easy and generally available to smaller companies. Consequently, inexpensive generic orthodontic brackets have recently become available. Since bracket design is relatively mature, this competition has forced companies to seek unique hi-tech product niches in the traditional tooth-moving bracket/archwire arena.

Since each patient and tooth moving treatment is unique, the specific force vectors required to achieve a desired result are also unique. In theory, if one could design a set of brackets and arch wires that provide these unique forces for individual patients, treatment time should be shortened. This technical approach is the subject of several U.S. patents. The basis for these technologies is briefly summarized and contrasted with the methods described in the present invention.

Prior art describes computer-based 3-dimensional methods for designing and fabricating custom appliances for repositioning teeth from a state of malocclusion to a final state of desired occlusion. A series of U.S. patents owned by Ormco Corporation (Orange, Calif.) describe methods for forming custom appliances for repositioning teeth towards calculated finished positions. Examples of such patents are U.S. Pat. Nos. 5,447,432, 6,015,289 and 6,244,861. Such appliances may consist of archwires and brackets. Computers are used to calculate archforms and the finished positions of teeth, design appliances to move the teeth to the finished position, and command machines to build the appliances. Another series of U.S. patents owned by Align Technology, Inc. (Sunnyvale, Calif.) describe computer-based methods for repositioning-teeth, determining treatment plans, and fabricating a series of polymeric shell appliances to sequentially reposition the teeth of a patient. Examples of such patents include U.S. Pat. Nos. 5,975,893, 6,299,440 and 6,318,994. Another U.S. patent owned by OraMetrix, Inc. (Dallas, Tex.) also describes computer-based methods for achieving tooth movement. The OraMetrix U.S. Pat. No. 6,350,120 is directed to the computer-based determination of tooth movement and the placing of brackets on the teeth in a zero force position.

Repositioning of teeth is the primary and common feature of prior art computer-based orthodontic treatment methods. These methods all require either the determination of a final desired state of occlusion, a series of intermediate occlusal states, an estimate of the forces required to achieve the desired tooth movement, or archform calculations. In contrast, the methods of the present invention do not involve any tooth repositioning or archform calculations. Only the patient's current dental anatomy and tooth position is used to design the wires produced by the present invention. These wires are for use in orthodontic appliances whose primary function is not to reposition teeth.

Following the computer-based design of the desired wire path for a particular appliance, a computer file is generated that details the centerline location of the wire and contains needed physical information about the wire such as the material of composition and diameter. This information is then translated into the code necessary to drive the servomotors of a wire bending machine. An example of a wire bending machine is found in U.S. Pat. No. 4,656,860.

### SUMMARY OF THE INVENTION

A primary objective of the present invention is to provide a practical and efficient method for the mass-customization and manufacture of orthodontic wireforms used to produce oral appliances. Such appliances include functional appliances such as Frankels, Bionators, and Activators, finishing and retention appliances, snoring and sleep apnea appliances, and Herbst appliances. The wires typically include labial bows (such as Hawley, Wraparound, Ricketts), clasps (such as arrow, finger, Adams, circumferential, and occlusal rests), springs (such as finger, “S”, mousetrap), Herbst frameworks (banded, cantilever, and splint), and sleep appliance frameworks. The bending of archwires to produce tooth movement is not a feature of the present invention.

The method comprises: 1) digitizing a patient's dentition and entering the data into a computer, 2) designing orthodontic appliance wires using the digitized models, 3) translating the wire's geometry and physical properties into an instruction set for commanding a wire bending machine, and 4) using a wire bending machine to produce near net-shape wires for orthodontic appliance fabrication.

The digitizing of a patient's oral structures may be accomplished by a number of established methods including optically scanning a model made from an impression, scanning an impression, or by direct intraoral scanning. The designing of complex 3-dimensional wire forms on the dental model may be accomplished using a point-to-point definition method or templates that consist of predefined algorithms. Translation of the wire path information into bending machine commands is accomplished through the integration of wire springback properties, bending machine servomotor algorithms, and the specific mechanics of the machine's bending head. Bending the final wire is accomplished using conventionally designed wire bending machines.

The time required to manually bend a wire for making an orthodontic appliance ranges from approximately three to fifteen minutes, depending upon the complexity of the wire and the skill of the technician. The physical bending step of this invention is extremely fast compared with existing manual methods. Typically, a machine can bend the most complex wireform required in less than 15 seconds. Also, the time required to design a wire with the aid of a computer (on the order of less than one minute) is short compared with the manual bending time. The initial digitizing of a dental model can be typically accomplished in less than two minutes. The cumulative timesaving provides a significant increase in production efficiency and reduction of cost. The methods described in this invention provide an efficient way to mass-customize the design and production of orthodontic wires.

The foregoing and additional advantages and characterizing features of the invention will become clearly apparent upon a reading of the ensuing detailed description together with the included drawings.

### BRIEF DESCRIPTION OF THE DRAWINGS

FIG. 1 is a generalized block diagram of the main method of this invention.

FIG. 2 is a block diagram of the main features of the dental application of the present invention.

FIG. 3 is a bock diagram of a fully computerized version of the present invention.

FIG. 4 is a block diagram of the main features of the wire design software.

FIG. 5 shows the location of example control points for a Hawley labial bow template.

FIG. 6 shows the Hawley labial bow produced by the computer using the control points shown in FIG. 5.

FIG. 7 is a close-up view of a Hawley labial bow showing details of the loop, interproximal area, and the lingual extension.

FIG. 8 shows the location of example control points for an Adams clasp.

FIG. 9 shows the Adams clasp produced by the computer using the control points shown in FIG. 6.

FIG. 10 illustrates a free-form designed wire that is relieved from the model surface by varying distances.

FIG. 11 illustrates a free-form designed wire form that is forced to travel a straight line between points on a model.

FIG. 12 illustrates a user-defined plane created as an occlusal plane in reference to a model and then moved palatally.

FIG. 13 illustrates a free-form designed wire that travels from a model surface, onto the plane of FIG. 12 and then back to the model surface.

FIG. 14 illustrates a free-form designed wire that follows a b-spline passing through all of the user-defined points.

FIG. 15 illustrates a free-form designed wire that follows a b-spline that is mathematically forced to follow a smoother path than that of FIG. 14.

FIG. 16 illustrates the main components of a small 2-pin wire bending machine.

FIG. 17 is a detailed front view of the bending head in the machine of FIG. 16.

FIG. 18 is a detailed side view of the bending head in the machine of FIG. 16.

The following detailed description is in such full, clear, concise and exact terms as to enable any person skilled in the art to which it pertains, or with which it is most nearly connected, to make and use the invention.

### DETAILED DESCRIPTION OF THE INVENTION

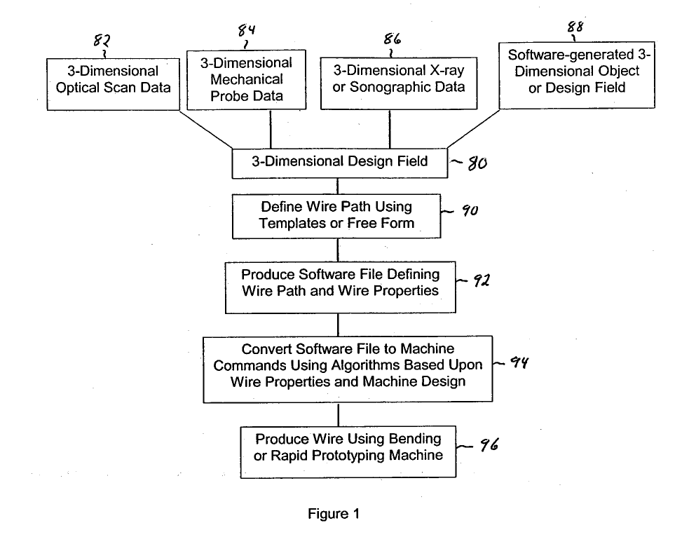

FIG. 1 illustrates the overall general methodology of this invention. The first step 80 is the creation of a 3-dimensional design field in a computer to serve as the basis for designing the desired wires. The design field can come from optically scanning 82 a physical object, physically touching 84 an object with a probe to digitize the surface, serial x-ray or sonographic data 86, or a user using standard 3-dimensional modeling software 88 may create the design field from scratch. These various procedures or processes for creating the 3-dimensional design field are well-known to those skilled in the art.

The next step 90 is the definition of the desired wirepath on the design field. The wirepath may be defined using predefined geometric rules in templates or a free-form method, all in a manner well-known to those skilled in the art. In general, the centerline of the wire is defined as a series of x,y,z points in space. The centerline data along with information about the wire material and diameter are saved in a text-based computer file 92. This computer file is then converted into a second computer file 94 which contains the specific commands to drive a wire bending machine. Providing such commands is well-known to those skilled in the art. The bending machine then produces 96 the desired wireform.

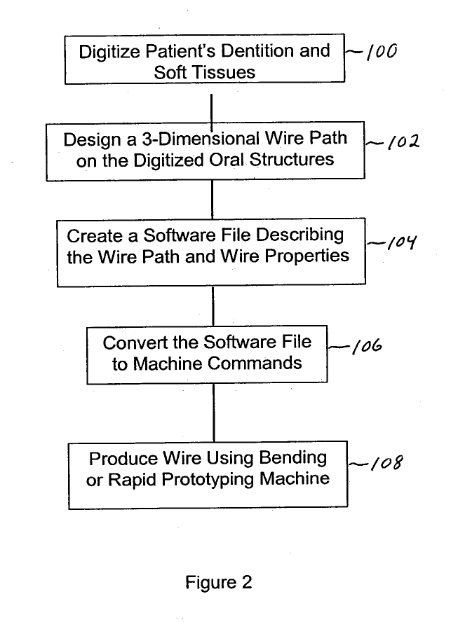

FIG. 2 illustrates the specific steps involved with the orthodontic application of this invention. The first step 100 involves digitizing a patient's teeth and surrounding soft tissues using established methods well-known to those skilled in the art. Next, a 3-dimensional wire is designed 102 over the design field using template and/or free-form methods all of which are well-known to those skilled in the art. It is not necessary for the computer to have any knowledge of the specific teeth present in the dental arch or even that the design field is a dental model. These data are saved in a computer file 104 which contains x,y,z data points that define the centerline of the wire, wire composition, and wire diameter. This computer file is then converted 106 to machine instructions used to drive the servomotors that run a wire bending machine. The last step 108 is the actual bending of the wire using the bending machine.

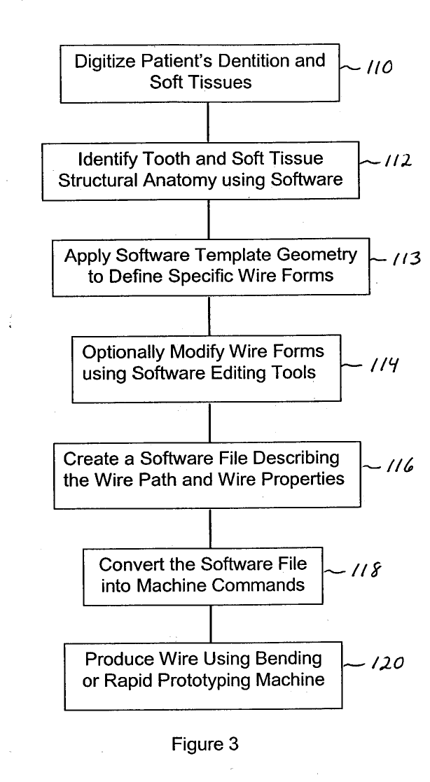

FIG. 3 is a block diagram of a fully computerized version of the present invention. This automated embodiment of the invention starts with the same digitizing 110 of the oral anatomy. The next step 112 is the identification of the hard and soft tissue borders. This step involves identifying which teeth are present and the location of the gingival margin. These data allow the use of geometric templates to directly define a wire. These templates utilize specific anatomic landmarks, derived from the identification step, to locate the wirepath. The templates define which anatomic landmarks the wire must pass through and the geometry of the wire between landmarks. After the template has been applied 113, the wireform may optionally be modified 114 using standard editing tools. A software file 116 is created that defines the centerline of the wirepath and the required wire properties (material and diameter). The wirepath file is then converted 118 to machine commands to drive a wire bending machine 120.

One component of the method of the present invention is the creation of the design field. Typically, an object will be digitized to provide the information needed to design the desired wire. Any 2- or 3-dimensional quantitative model can form the basis of this needed information, or design field. These data may be a patient's dentition, the exterior shape or skin of an animated model, or a 3-dimensional rendition of CAT scan data. The type and form of the design field information is not important to carrying out the methods of this invention. A dental application is used to demonstrate the usefulness of the invention.

A variety of established methods may be used to digitize the dentition and surrounding soft tissues of the mouth in the step designated 110 in FIG. 3. Two methods commonly used are: optically scanning a plaster model produced from an impression, and scanning the impression. Plaster models made from impressions may be optically scanned using well-established methods and commercially available scanning equipment such as the VIVIDTM series cameras made by Minolta Corporation. The surface of a dental impression may also be measured using x-ray methods, or the impression may be filled with a contrasting material and serially sectioned. The particular method used to digitize the teeth and oral structures is also not critical to the execution of this invention. The important aspect of the digitizing step is the creation of a quantitative 3-dimensional computer model with sufficient detail that is capable of providing the required design field.

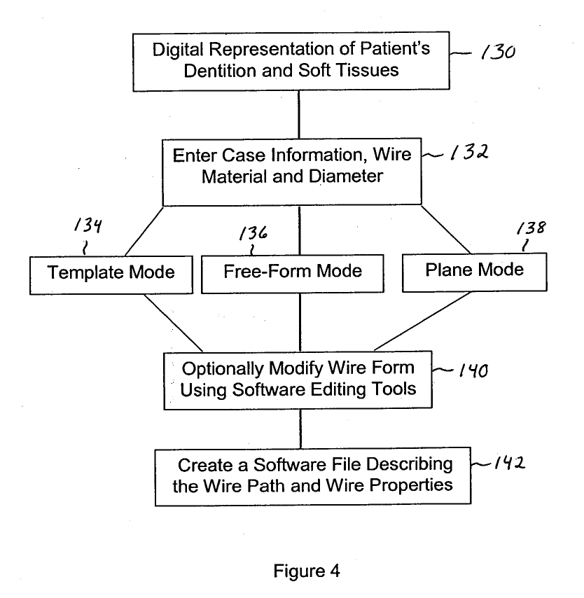

An important objective of the method of this invention is the computer-based design of orthodontic wires. It is important to realize that this invention, and in particular the wire design software, may be applied to any 2- or 3-dimensional design field. FIG. 4 is a basic block diagram of the wire design software. A 3-dimensional model 130 of a patient's dentition is used as the design field. A computer file of a previously digitized dental model is open on the computer screen. Basic information about the case is entered into the software 132 including a case number, doctor's name, date, wire material and wire diameter. The technician then begins the wire design phase. In this example, three design modes are used: Template 134, Free-form 136, and Plane 138. Each of these modes is separately illustrated in subsequent figures.

The method illustrated in FIG. 4 includes the optional step 140 of modifying the wire form using software editing tools. The last step 142 in the method of FIG. 4 is creating a software file describing the wire path and wire properties.

While each orthodontic wire produced by the present invention may be unique, a family of generic forms or templates may be defined that correspond to standard types of orthodontic wires. The geometry of each template may be readily defined using an ideal or standard dental model. Template definition includes defining key anatomic locations along the wire path and the geometry to be used to connect these landmarks. The template mode 134 thereby uses pre-defined geometric relationships to define a wireform based upon a small number of user-entered locations or landmarks. In this way substructures such as clasps, or other predefined forms, may be automatically designed as a subunit. Landmarks are identified by simply clicking the computer cursor on the model surface.

After the Template mode 134 is entered, the user selects the type of wire to be designed, such as a Hawley labial bow or an Adams clasp. Once a selection has been made, the wire design software presents a series of prompts to the user. These prompts lead the user through the process of identifying the required key anatomic landmarks for the particular template. User-defined points can be moved and redefined as needed. When the last point is identified, the software automatically calculates and displays the desired wireform. Once applied, template form may be modified using the free-form method or other editing tools to better fit the dental model.

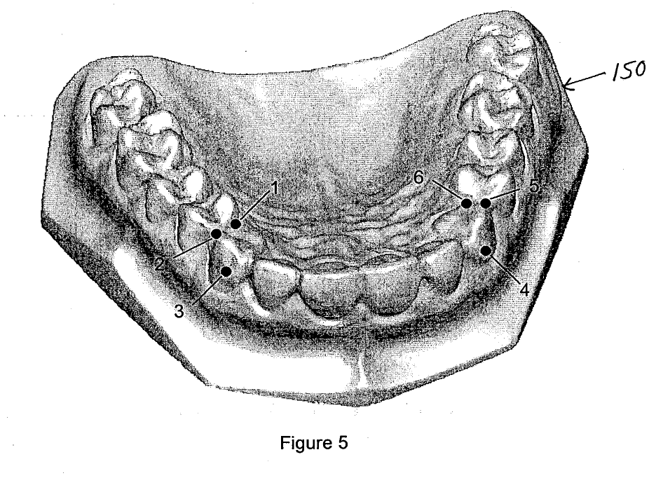

FIG. 5 shows the location of example control points on a dental model 150 for a Hawley labial bow template. Points 1 and 2 (and 5 and 6) are interproximal points that define the end-points of the lowest possible profile path for the wire to take between the teeth. The wire also extends lingually from points 1 and 6 towards the palate. The lingual section may be pre-defined in the template or additional control points may be used to direct the wire in a specific direction. Points 3 and 4 are the contact points on the cuspids.

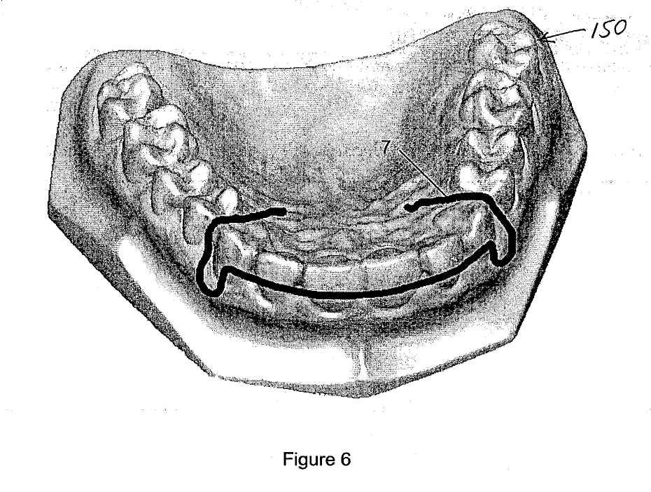

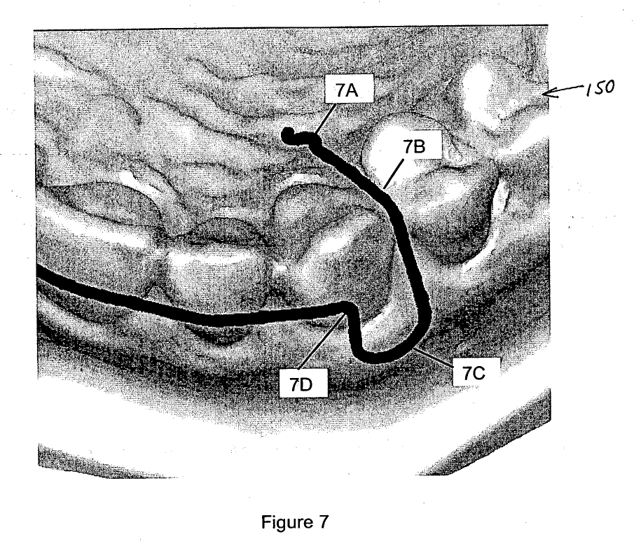

FIG. 6 illustrates the labial bow (7) produced using the landmarks shown in FIG. 5. FIG. 7 is a close-up view of the same labial bow. The segment labeled 7A is the lingual extension which is automatically relieved 1 mm from the palate to allow the wire to be captured in acrylic. Segment 7B is the interproximal segment defined by points 5 and 6 in FIG. 6. Section 7C shows a 6 mm deep loop that extends towards the soft tissue and is relieved 1 mm from the model surface. Point 7D corresponds to point 4, which is a contact point on the cuspid. The front bow section is made to contact the outermost point of the central incisors.

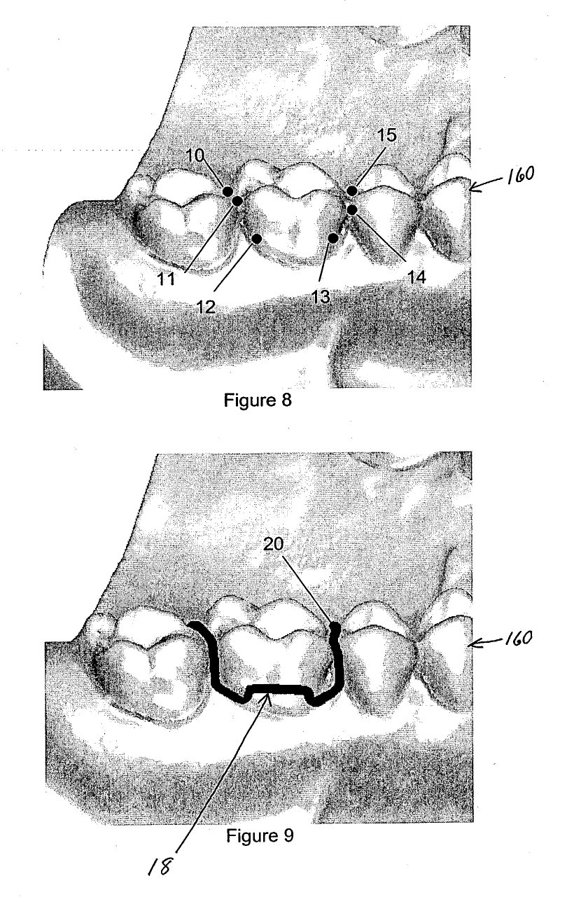

FIG. 8 shows the location of example control points on a dental model 160 for an Adams clasp. Points 10 and 11 (as well as 14 and 15) represent interproximal points. Points 12 and 13 are the clasp contact points on this particular tooth. FIG. 9 shows the Adams clasp 18 produced using these control points. Section 20 indicates the lingual extension that starts at point 15 in FIG. 8. The template produces a clasp with a horizontal cross bar and the required 45° angles on the semicircular clasp points.

The Free-form mode designated 136 in FIG. 4 allows users to define wireforms point wise by clicking on the model surface. A spline is normally passed through the defined points. Some of the design tools available in this mode include: adding points within a line segment, deleting point, moving points, relieving points off (normal to) the model surface by settable amounts, designing wires on predefined planes, and designing wires to go point-to-point instead of following a spline.

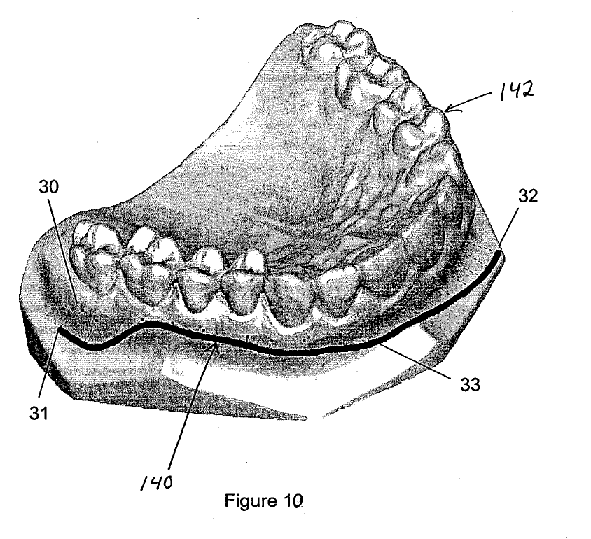

FIG. 10 illustrates a free-form designed wire 140 having different amounts of relief from the surface of a model 142. Point 30 represents a user-defined point. Point 31 is the point determined by the software to be relieved 4 mm normal to the surface. An average is taken of the vectors surrounding the user-defined point over a specified area. Point 32 is relieved 5 mm and point 33 is relieved only 3 mm. The wire path is seen to follow a spline between the defined points.

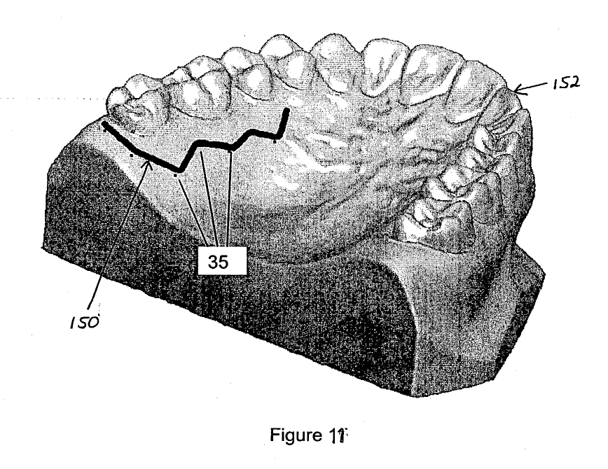

FIG. 11 illustrates a free-form designed wire 150 where the wire path is forced to travel a straight line between points on a model 152. A small amount of curvature must be imposed at the bend points 35 to ensure that the wire can be bent.

The Plane mode designated 138 in FIG. 4 is used to define planes for designing wires off the model surface. Planes may be defined by either a 3-point method or a line method. The 3-point method allows the user to click three points on the model to define a plane. The line method allows the user to drag a straight line across the model surface to define the line along the surface where the plane intersects the model. Planes may be moved parallel to themselves to allow variable placement. Planes extended off the model or between the upper and lower arches to accommodate the design of wires traveling in any desired region of space. Wires may be defined completely within a plane, between a plane and the model surface, or between two planes.

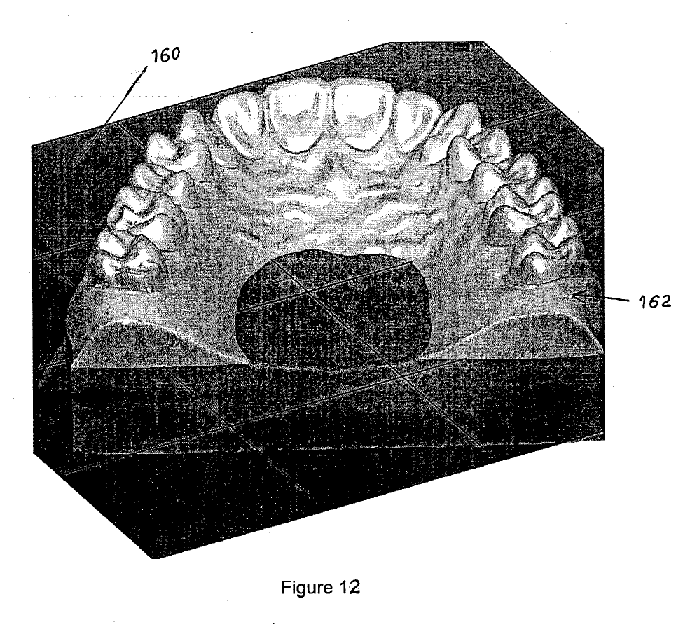

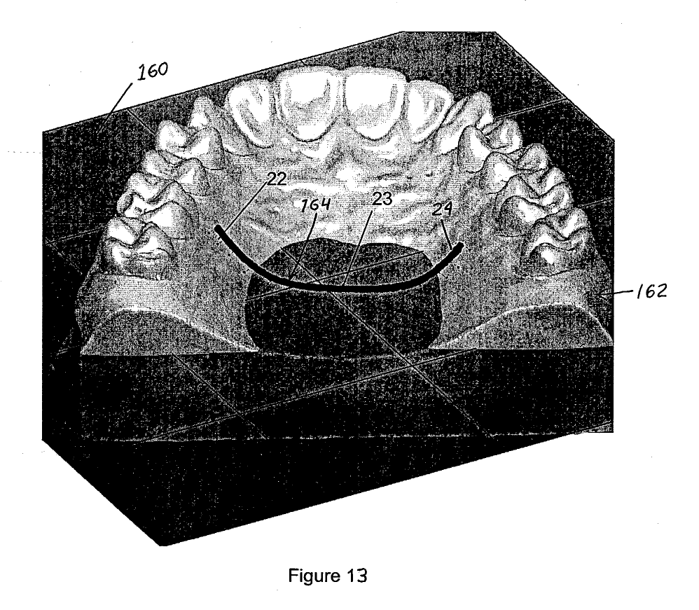

FIG. 12 illustrates a user-defined plane 160 that was created as an occlusal plane in reference to a model 162 and then moved palatally. FIG. 13 shows a free-form designed wire 164 having a portion (22) that extends from the model surface, a portion (23) that extends onto the defined plane (160), and a portion (24) that extends back to the model surface.

After a basic wireform has been designed, a number of editing tools are available. Editing tool functions include: 1) adding points to a line segment, 2) deleting points, 3) moving or relocating points by dragging them over the design field, 4) joining segments, 4) joining a template-produced wire to a free-form wire, and 5) changing the ‘tension’ of the wire.

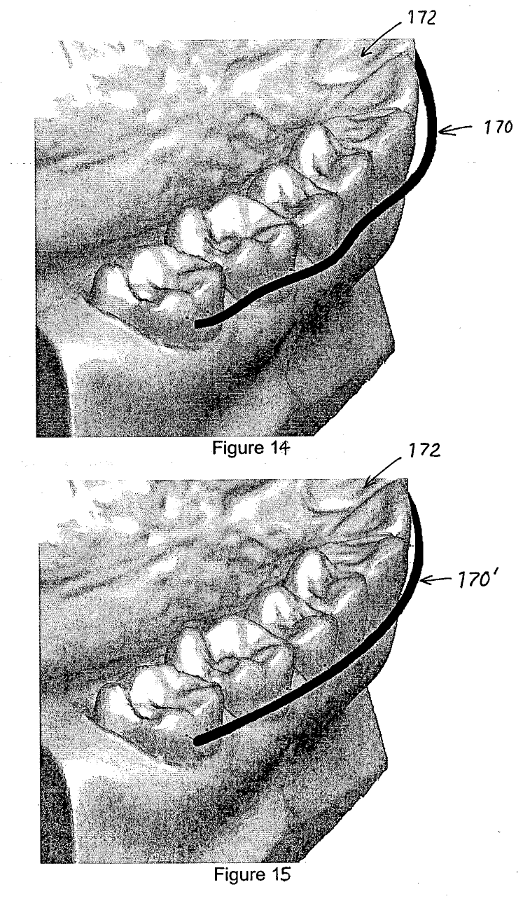

Tension control is used to reduce the degree to which a wire changes curvature over its length. Zero tension control forces the wire to pass through all of the user-defined control points of the spline. Increased tension places less mathematical weight to the points that cause the line curvature to change the most, thereby straightening the wire. FIGS. 14 and 15 show the effect of increased tension on the curvature of a wire. FIG. 14 shows a spline 170 forced to pass through all of the user-defined points (zero tension) on a model 172. FIG. 15 shows the same wire path with increased tension which straightens the wire designated 170′ in FIG. 14. Points that contribute to increased curvature are given less weight.

The last step of the wire design process, as shown at 142 in FIG. 4, is the creation of a computer file that contains data to describe the 3-dimensional path of the wire as well as the material of composition and diameter of the wire.

Several ways exist to mathematically represent wires as 3-dimensional line paths; the precise mathematical form used is not critical. The data file defining the wire is typically a simple text file containing the x,y,z point values of the wire path at a certain line density. The number of points per unit length, or point density, can vary depending upon the radius of curvature of the wire, with segments of greater curvature requiring more points per unit length than straighter segments. Alternate methods can be similarly effective in defining a wireform, and do not represent a significant departure from the principles of the present invention.

In a preferred embodiment of this invention, the 3-dimensional wire path is a polyline defined as a series of splines and straight segments. Software allows spline segments to be independently controlled for shape, and the polyline is represented as a series of x,y,z values.

Another aspect of the present invention is the translation of wire path and wire material/diameter information to bending machine instructions. A variety of wire bending machines are known in the present art. Design differences mainly relate to the mechanical systems used to manipulate the feed wire and create the bend. The mechanical process used to effect the physical bend in the wire is unrelated to executing the methods of this invention.

Bending wires for orthodontic appliances by this invention requires the production of near net-shape wires that need only minor adjustment by a technician to acceptably incorporate into an orthodontic appliance. Wire bending machines are generally used to produce large numbers of the same part, and a trial-and-error method is typically required to develop the machine instruction set to produce the desired final part geometry. This is mainly due to the springback of metal when it is bent. Creating a specific angular bend in a wire requires the wire to be bent beyond this value to accommodate the spring back of the metal. Consequently, producing near net-shaped wire forms requires detailed consideration of the spring back properties of metal wires. Machine control algorithms must consider the spring back of different metals and the mechanics of a particular bending head. The method of this invention requires the machine control algorithms to be finely tuned to account for the mechanical properties of the wire, in order to produce the most accurate wire.

Since each metal has different spring-back properties and the tooling used to bend wires is typically size-dependent, the wire diameter and type of metal are important parameters for determining the algorithm used to drive the bending machine.

Software controls used to command bending machines are all based upon similar methods and principles that are well known to those skilled in the art. All wire bending machines ultimately use motors or actuators to feed, rotate, and effect bends in the wire. The required motor command signal (usually the analog or digital output from a computer) used to drive the motors and effect specific bends also varies from machine to machine.

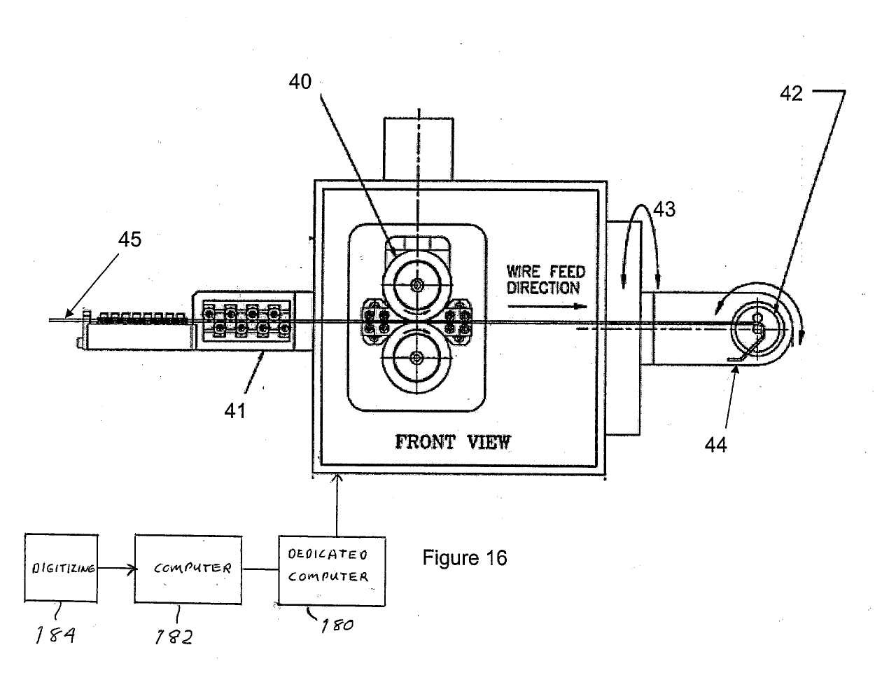

FIG. 16 shows a front view of a 2-pin wire bending machine. The unit is typically driven by digitally-controlled servomotors. The complete bending system consists of a motorized wire pay-off system to ensure a straight feed at uniform tension, and the bending machine itself. A dedicated computer 180 runs the system. Operatively coupled to dedicated computer 180 is the computer 182 previously described containing the software program(s) for, briefly, creating the 3-dimensional design field, providing the definition of the desired wire path on the design field and providing commands to drive the machine. The digitizing of the patient's oral structure is represented by the input 184 to computer 182. The machine is capable of bending wire 0.010 to 0.125 in. diameter. The incoming feed wire, typically from a motorized spool-off system, is shown as 45. Wire is drawn into the machine by a set of power rollers, 40. Upon entering the bending machine, any cast is removed from the wire by drawing it through a set of perpendicular wire straighteners 41. The straightened wire is then fed to the bending head 42. Rotary motion of head 42 in the horizontal plane as viewed in FIG. 16 pivots the forming mandrel around the wire to achieve 3-dimensional bending capability. Rotation 43 is around the wire axis. The bent wire is shown as 44. The design of the bending head is central to the machine's operation. A 2-pin design is typically used for complex 3-dimensional geometries, while standard NC-type spring forming machines may be used to produce simpler shapes that include any number of loops.

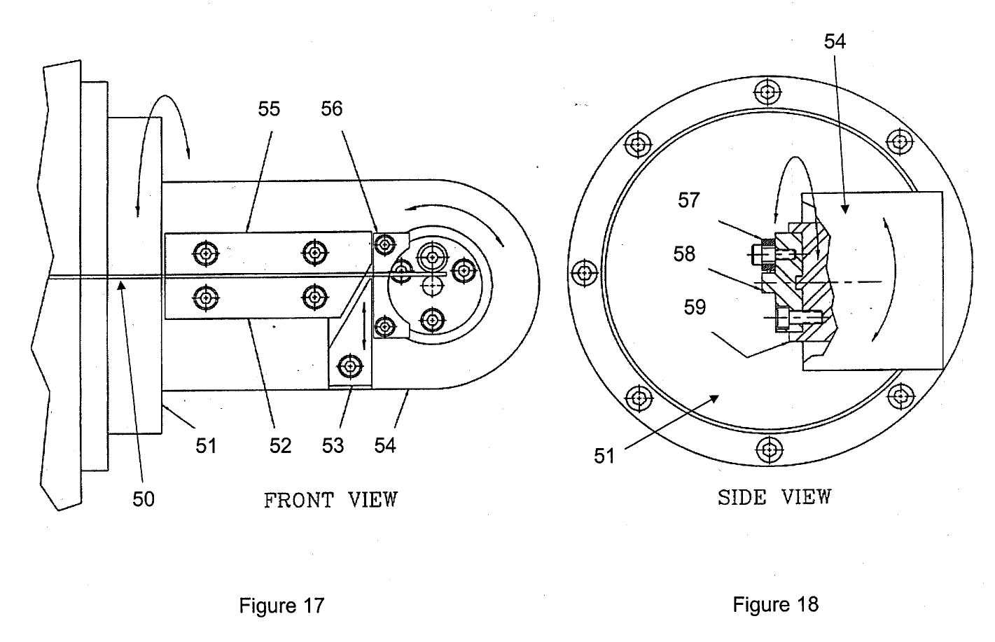

FIG. 17 illustrates more details of the bending head. The incoming feed wire is shown as 50. The vertical rotary turret is shown as 51. The horizontal rotary arm 54 rotates about the wire center perpendicular to the face of 51. The wire runs between the upper and lower replaceable wire guides 52 and 55. The wire is cut using a replaceable cutter tool 53. Item 56 is a replaceable support to assist with cutting the wire.

FIG. 18 is a detailed side view of the horizontal rotary arm 54 and mandrel head 59. The wire is fed between a replaceable stationary central forming mandrel 58 and a replaceable outer grooved roller wheel 57. The roller wheel rotates with the mandrel head to bend the wire over the forming mandrel. Rotation of the entire mandrel head about the vertical rotary turret provides the needed third dimension capability.

The gap between the grooved roller wheel 57 and the forming mandrel 58 is a critical dimension. Increasing this gap reduces the minimum bend radius possible by the machine. This gap should be kept as small as possible. The diameter of the forming mandrel 58 is also desired to be as small as possible to allow the machine to produce tight bends. If forming mandrel 58 is made too small however, it will not have sufficient strength to allow the wire to be formed around itself.

The dimensions of the roller wheel 57, forming mandrel 58, and the associated gap, are typically optimized for each wire diameter. Such part-dedicated tooling is the most accurate and efficient way to bend a particular diameter wire. Mechanical systems, such as automatic indexing systems, are readily designed and fabricated that would allow the rapid changing of mandrel heads to allow one bending machine to efficiently bend different wire diameters. Also, semiautomatic wire changing systems may be design and fabricate to accommodate the feeding of various diameter wires to the bending system.

It is important that the defined wire be bendable and also not pass into the model surface. Software ensures that the wire does not enter the model surface by providing a visual indication to the user, such as a change of color to indicate interference between the wire and the model. Software is also used to ensure that the wire is bendable. The bendability of a wire depends upon a number of factors such as: wire diameter, mandrel component diameters and gaps, and limitations of the wire path (such as looping back on itself).

While an embodiment of the present invention has been described in detail, that is for the purpose of illustration, not limitation.

1. A computer-based design and manufacturing method of producing custom wires for fabricating dental appliances, the method comprising:
a) digitizing a patient's dentition and surrounding soft tissue and inputting the digitized information into a computer,
b) utilizing software in the computer to design the path of wires for fabricating dental appliances based only upon the patient's current tooth positions and arcuate dental structure,
c) translating digital data describing physical and geometric information about the wire into machine algorithms to command a wire bending machine, and
d) utilizing the machine algorithms to produce a digitally-designed wire using a wire bending machine.

2. The method according to claim 1 wherein the wires are designed on planes defined with respect to the model and are located off the model surface.

3. The method according to claim 1 wherein the wires are designed using a template for standardized forms, wherein such templates contain the anatomic location information required to adequately define the 3-dimensional path relative to a dental model, and wherein after a template has been applied to an example dentition, the said wire path may be further modified to improve appliance design.

4. The method according to claim 1 wherein the designed wire includes a labial bow, Herbst framework, clasp, or expansion device component.

5. The method according to claim 1 wherein the wires are designed to bridge upper and lower dental arches.

6. The method according to claim 1 wherein the said wire design includes mechanical means for attaching said wire to a second component of an orthodontic device.

7. The method according to claim 1, wherein the digitizing a patient's dentition and surrounding soft tissue is from intraoral scans.

8. The method according to claim 1, wherein the digitizing a patient's dentition and surrounding soft tissue is from an impression.

9. The method according to claim 1, wherein the digitizing a patient's dentition and surrounding soft tissue is from a model produced from an impression.

10. A method of producing custom wires for fabricating dental appliances using computer-based design and manufacturing, the method comprising:
a) defining a wire path directly on the patient using an intraoral probe and inputting the information obtained into a computer,
b) utilizing software to render the patient data and design wires for fabricating dental appliances based only upon the patient's original tooth position and arcuate dental structure,
c) translating the digital data that describes the desired wire geometry into machine algorithms to command a wire bending machine, and
d) utilizing the machine algorithms to produce the digitally-designed wire using a wire bending machine.

11. In a computer-based design and manufacturing method of producing custom wires for fabricating dental appliances wherein digital information obtained on a patient's dentition is input to a computer to produce instructions for a computer controlled wire bending machine, a wire design process comprising:
a) utilizing a three dimensional model of the patient's dentition as a design field;
b) processing patient and wire information into the design field;
c) selecting a design mode from the group consisting of a template mode, a free-form mode and a plane mode; and
d) utilizing the design field and the selected design mode to create a software file describing wire path and wire properties.

12. The method according to claim 11, wherein the template mode uses pre-defined geometric relationships to define a wireform based upon user specified locations.

13. The method according to claim 11, wherein the free-form mode includes passing a spline through defined wireform points.

14. The method according to claim 11, wherein the plane mode includes defining planes on a model surface and moving the planes relative to the surface.

15. A system for producing custom wires for dental appliances comprising:
a) a computer-operated wire bending machine;
b) means for digitizing a patient's dentition and surrounding soft tissue; and
c) a computer having an input coupled to the digitizing means to receive digitized information on the patient's dentition and having an output operatively coupled to the computer-operated wire bending machine, the computer including stored program means to design wire paths for fabricating dental appliances based only upon the patient's current tooth positions and arcuate dental structure, the computer also including stored program means for translating digital data describing physical and geometric information about the wire into machine algorithms to produce digitally-designed wire on the wire bending machine.
